(19) United States
(12) Patent Application Publication
(10) Pub. No.: US 2009/0197068 A1
(43) Pub. Date: Aug. 6, 2009

(54) POLYIMIDE FILM, AND METHOD FOR PRODUCTION THEREOF

(75) Inventors: Hiroaki Yamaguchi, Ube-shi (JP); Masafumi Kohda, Ube-shi (JP); Nobuharu Hisano, Ube-shi (JP); Shinsuke Yabunaka, Ube-shi (JP)

Correspondence Address: KNOBBE MARTENS OLSON & BEAR LLP, 2040 MAIN STREET, FOURTEENTH FLOOR, IRVINE, CA, 92614, US

(73) Assignee: UBE INDUSTRIES, LTD., Ube-shi (JP)

(21) Appl. No.: 12/363,546

(22) Filed: Jan. 30, 2009

(30) Foreign Application Priority Data
Feb. 1, 2008 (JP) 2008-023281

(51) Int. Cl. C08G 69/26; B32B 15/08; B28B 1/14

(52) U.S. Cl. 428/220; 528/353; 428/458; 264/299

(57) ABSTRACT

Disclosed is a polyimide film prepared from an aromatic tetracarboxylic acid component consisting essentially of 3,3′,4,4′-biphenyltetracarboxylic dianhydride and an aromatic diamine component consisting essentially of not less than 65 mol phenylenediamine % but less than 97 mol % of p-phenylenediamine and not less than 3 mol % but less than 35 mol % of 2,4-toluenediamine.

### TECHNICAL FIELD

The present invention relates to a polyimide film having an excellent productivity, and a method for producing a polyimide film with high productivity. The present invention also relates to a polyimide film having an improved adhesiveness, while maintaining the excellent properties of a conventional polyimide film.

### BACKGROUND ART

A polyimide film is widely used in various applications such as the electric/electronic device field and the semiconductor field, because it has excellent heat resistance, chemical resistance, mechanical strength, electric properties, dimensional stability and so on. For example, a copper-clad laminate wherein a copper foil is laminated on one side or both sides of a polyimide film is used for a flexible printed circuit board (FPC).

One example of the polyimide films suitable as films for FPC, and the like is a polyimide film prepared from an aromatic tetracarboxylic acid component comprising 3,3′,4,4′-biphenyltetracarboxylic dianhydride as a main component and an aromatic diamine component comprising p-phenylenediamine as a main component by a thermal imidization (for example, Patent document 1).

Conventionally, a polyimide film may be produced as follows:

Firstly, a polyimide precursor solution is prepared by reacting substantially equimolar amounts of an aromatic tetracarboxylic dianhydride and an aromatic diamine in an organic solvent. And then, a self-supporting film of a polyimide precursor solution is prepared by flow-casting the solution of the polyimide precursor on a support, and heating it sufficiently to make it self-supporting, which means a stage before a common curing process; specifically, heating it at 100 to 180° C. for about 2 to 60 min. Subsequently, a solution of a coupling agent is applied to the surface of the self-supporting film of the polyimide precursor solution, if necessary, for the purpose of improving the adhesive property of the obtained polyimide film. And then, the self-supporting film is heated to effect imidization, thereby producing a polyimide film.

From the viewpoint of the productivity, it is preferable to use a high-concentration solution of a polyimide precursor with a small amount of a solvent, thereby reducing the thermal energy and the heating time required for solvent removal (drying) to obtain a self-supporting film of a polyimide precursor solution. However, a solution of a polyimide precursor prepared from 3,3′,4,4′-biphenyltetracarboxylic dianhydride and p-phenylenediamine with a higher concentration may have less storage stability, and may gel when being stored for a long time.

In addition, from the viewpoint of the productivity, it is preferable to form a self-supporting film of a polyimide precursor solution at a higher speed so as to increase production per unit time. However, when forming a self-supporting film of a polyimide precursor solution prepared from 3,3′,4,4′-biphenyltetracarboxylic dianhydride and p-phenylenediamine at a higher speed, the obtained self-supporting film may be inferior in properties such as an initial elastic modulus, and inferior in handling properties. Furthermore, the obtained polyimide film may be inferior in properties; for example, the obtained polyimide film may be more frangible, and may be foamed, and a crystal may be formed therein.

Meanwhile, a polyimide film may not have sufficiently high adhesive properties. When a metal foil such as a copper foil is bonded onto a polyimide film with a heat-resistant adhesive such as an epoxy resin adhesive, a laminate having sufficiently high peel strength may not be obtained.

For example, Patent document 1 discloses a process for producing a polyimide film wherein a surface treatment solution containing a heat-resistant surface treating agent (coupling agent) is applied to a surface of a self-supporting film (a solidified film) of a polyimide precursor solution for improving the adhesive property of the obtained polyimide film. Hence, there is the need for a polyimide film having an excellent adhesive property which may be produced without applying a solution of a coupling agent onto the self-supporting film of the polyimide precursor solution.

In addition, Patent document 2 discloses a polyimide obtained by reacting a biphenyltetracarboxylic dianhydride with an aromatic diamine having two amino groups which are in the meta-positions relative to each other; specifically, a polyimide film obtained by reacting 3,3′,4,4′-biphenyltetracarboxylic dianhydride with 2,4-toluenediamine, for example, as a colorless transparent polyimide molded product which is used for a liquid crystal alignment film, and the like.

Patent document 3 discloses a solvent-soluble polyimide comprising 81 mol % to 51 mol % of the repeating unit derived from an aromatic tetracarboxylic dianhydride and an aromatic tetra-nuclear diamine, 1 mol % to 4 mol % of the repeating unit derived from an aromatic tetracarboxylic dianhydride and diaminosiloxane, and 18 mol % to 45 mol % of the repeating unit derived from an aromatic tetracarboxylic dianhydride and 2,4-toluenediamine, as a polyimide which is used for a liquid crystal alignment film of a liquid crystal display element. In Patent document 3, 3,3′,4,4′-biphenyltetracarboxylic dianhydride is given as an example of an aromatic tetracarboxylic dianhydride. Patent document 3 also discloses that toluenediamine may be capable of imparting excellent solubility to the polyimide.

Citation List

Patent document 1: Japanese Examined Patent Application Publication No. 1994-002828;

Patent document 2: Japanese Laid-open Patent Publication No. 1987-13436;

Patent document 3: Japanese Laid-open Patent Publication No. 1986-240223.

### SUMMARY OF INVENTION

An objective of the present invention is to provide a polyimide film having an excellent productivity, which comprises the constitutional unit derived from 3,3′,4,4′-biphenyltetracarboxylic dianhydride and p-phenylenediamine as a main constitutional unit; and a method for producing the polyimide film with high productivity.

Another objective of the present invention is to provide a polyimide film having an improved adhesive property, while maintaining the excellent properties of a polyimide film.

The present invention relates to the followings.

A polyimide film prepared from an aromatic tetracarboxylic acid component comprising 3,3′,4,4′-biphenyltetracarboxylic dianhydride as a main component and an aromatic diamine component comprising p-phenylenediamine as a main component; wherein the aromatic diamine component comprises not less than 3 mol % but less than 35 mol % of 2,4-toluenediamine based on the total molar quantity of the aromatic diamine component.

The polyimide film as described in [1], wherein the aromatic diamine component comprises 5 mol % to 30 mol % of 2,4-toluenediamine based on the total molar quantity of the aromatic diamine component.

The polyimide film as described in [1], wherein the polyimide film has a thickness of 3 μm to 250 μm.

The polyimide film as described in [1], wherein the polyimide film has a thickness of 75 μm to 250 μm.

A process for producing a polyimide film as described in [1], comprising steps of:

providing a solution of a polyimide precursor prepared from an aromatic tetracarboxylic acid component consisting essentially of 3,3′,4,4′-biphenyltetracarboxylic dianhydride and an aromatic diamine component consisting essentially of not less than 65 mol % but less than 97 mol % of p-phenylenediamine and not less than 3 mol % but less than 35 mol % of 2,4-toluenediamine;

flow-casting the solution of the polyimide precursor on a support and heating it, thereby preparing a self-supporting film of a polyimide precursor solution; and

heating the self-supporting film to effect imidization.

The process for producing a polyimide film as described in [5], wherein the solution of the polyimide precursor which is flow-casted on a support has a solid content of 18 wt % to 30 wt %.

The process for producing a polyimide film as described in [5], wherein the self-supporting film produced has an initial elastic modulus of 500 MPa or higher.

A copper-laminated polyimide film, wherein a copper foil is laminated on the surface of the polyimide film as described in [1] via an adhesive layer or a thermocompression-bonding layer.

The copper-laminated polyimide film as described in [8], wherein the copper-laminated polyimide film has a 90° peel strength of 0.3 N/mm or higher.

The polyimide film of the present invention comprises the polyimide component (A) derived from 3,3′,4,4′-biphenyltetracarboxylic dianhydride and 2,4-toluenediamine, which is random-copolymerized or block-copolymerized therein, in the range of 3 mol % to 35 mol % (excluding 35 mol %), preferably 5 mol % to 30 mol %, more preferably 7 mol % to 25 mol %. When producing the polyimide film of the present invention,
(1) a polyimide precursor solution with a higher concentration may be prepared and used; and
(2) a self-supporting film of a polyimide precursor solution may be produced at a higher film-forming rate, using the high-concentration solution of a polyimide precursor,
as compared to a polyimide film which does not comprise the polyimide component (A). Furthermore, even when forming a self-supporting film of a polyimide precursor solution at a high speed, the obtained self-supporting film and the obtained polyimide film may have the excellent properties without deteriorating.

A solution of a polyimide precursor to give the polyimide of the present invention is more stable even in high concentrations, as compared to a solution of a polyimide precursor prepared from 3,3′,4,4′-biphenyltetracarboxylic dianhydride and p-phenylenediamine. A solution of a polyimide precursor to give the polyimide film of the present invention does not gel, or seldom, if ever, gel when being stored for a long time. Consequently, according to the present invention, a polyimide precursor solution with a higher concentration may be used for the production of a self-supporting film, and therefore the thermal energy and the heating time required for solvent removal (drying) to obtain a self-supporting film may be reduced.

Furthermore, in case of the polyimide film of the present invention which comprises the polyimide component (A), even when forming a self-supporting film of a polyimide precursor solution at a high speed, there is less deterioration in the tensile properties such as an initial elastic modulus of the obtained self-supporting film, as compared to a self-supporting film of a polyimide precursor solution prepared from 3,3′,4,4′-biphenyltetracarboxylic dianhydride and p-phenylenediamine. When using a polyimide precursor solution with a high concentration, in particular, the obtained self-supporting film of the polyimide precursor solution has sufficiently high tensile properties, even though forming the self-supporting film at a high speed, as compared to a self-supporting film of a polyimide precursor solution prepared from 3,3′,4,4′-biphenyltetracarboxylic dianhydride and p-phenylenediamine. Therefore, according to the present invention, a self-supporting film of a polyimide precursor solution may be produced at a higher film-forming rate, without deteriorating handling properties of the obtained self-supporting film.

According to the present invention, a polyimide precursor solution with a higher concentration may be used, and a self-supporting film of a polyimide precursor solution may be produced at a higher film-forming rate; and therefore the productivity may be enhanced in the production of a thin polyimide film with a thickness of about 3 μm, for example, as well as in the production of a thicker polyimide film. Meanwhile, the effect of improving productivity may be more remarkably obtained especially when producing a relatively thick polyimide film with a thickness of 50 μm or more, more preferably 75 μm or more.

The polyimide component (A) is preferably obtained from 3,3′,4,4′-biphenyltetracarboxylic dianhydride and 2,4-toluenediamine. When 2,4-toluenediamine is copolymerized, the obtained polyimide film may have an improved adhesive property. Furthermore, the obtained polyimide film may have improved water-vapor permeability, and coloring is expected to be reduced. As described above, the effect of improving productivity may be more remarkably obtained when producing a relatively thick polyimide film. In contrast, the effect of improving adhesiveness may be obtained when producing a thin polyimide film as well as when producing a relatively thick polyimide film. According to the present invention, there may be provided a thin polyimide film with a thickness of about 3 μm which has a high adhesiveness, for example.

In the present invention, the content of the polyimide component (A) is essentially not less than 3 mol % but less than 35 mol %, preferably 5 mol % to 30 mol %, more preferably 7 mol % to 25 mol %. When the content of the polyimide component (A) is less than 3 mol %, the effect of improving productivity and adhesiveness may not be sufficiently obtained. When the content of the polyimide component (A) is not less than 35 mol %, the obtained polyimide film may be inferior in properties.

### DESCRIPTION OF EMBODIMENTS

The polyimide film of the present invention is prepared from an aromatic tetracarboxylic acid component comprising 3,3′,4,4′-biphenyltetracarboxylic dianhydride as a main component, and an aromatic diamine component comprising p-phenylenediamine as a main component and 3 mol % to 35 mol % (excluding 35 mol %) of 2,4-toluenediamine. Accordingly, the polyimide film of the present invention comprises the constitutional unit derived from 3,3′,4,4′-biphenyltetracarboxylic dianhydride and p-phenylenediamine as a main constitutional unit; and the polyimide component (A) derived from 3,3′,4,4′-biphenyltetracarboxylic dianhydride and 2,4-toluenediamine, which is random-copolymerized or block-copolymerized therein, in the range of 3 mol % to 35 mol % (excluding 35 mol %).

The content of the polyimide component (A) is preferably 3 mol % or more, more preferably 5 mol % or more, particularly preferably 7 mol % or more. In addition, the content of the polyimide component (A) is preferably less than 35 mol %, more preferably 30 mol % or less, particularly preferably 25 mol % or less.

The polyimide film as described above may be produced as follows. Firstly, a polyimide precursor is synthesized by reacting an aromatic tetracarboxylic acid component comprising 3,3′,4,4′-biphenyltetracarboxylic dianhydride as a main component, and an aromatic diamine component comprising p-phenylenediamine and 2,4-toluenediamine to give a predetermined content of the polyimide component (A). And then, the solution of the polyimide precursor thus obtained is flow-casted on a support and heated, thereby producing a self-supporting film of a polyimide precursor solution. Subsequently, the self-supporting film is heated to effect imidization, thereby producing a polyimide film.

A self-supporting film of a polyimide precursor solution may be prepared by flow-casting a solution of a polyimide precursor in an organic solvent to give a polyimide on a support, after adding an imidization catalyst, an organic phosphorous compound and/or an inorganic fine particle to the solution, if necessary, and then heating it sufficiently to make it self-supporting, which means a stage before a common curing process.

The polyimide precursor used in the present invention is prepared from an aromatic tetracarboxylic acid component comprising 3,3′,4,4′-biphenyltetracarboxylic dianhydride (hereinafter, sometimes abbreviated as “s-BPDA”) as a main component to give a predetermined content of the polyimide component (A), and an aromatic diamine component comprising p-phenylenediamine (hereinafter, sometimes abbreviated as “PPD”) as a main component to give a predetermined content of the polyimide component (A). Specifically, an aromatic tetracarboxylic acid component may preferably comprise 50 mol % or more, more preferably 70 mol % or more, further preferably 75 mol % or more of s-BPDA. An aromatic diamine component may preferably comprise 50 mol % or more, more preferably 70 mol % or more, further preferably 75 mol % or more of PPD.

A preferable polyimide precursor may be prepared from an aromatic tetracarboxylic acid component consisting essentially of 3,3′,4,4′-biphenyltetracarboxylic dianhydride and an aromatic diamine component consisting essentially of not less than 65 mol % but less than 97 mol % of p-phenylenediamine and not less than 3 mol % but less than 35 mol % of 2,4-toluenediamine; more preferably prepared from an aromatic tetracarboxylic acid component consisting essentially of 3,3′,4,4′-biphenyltetracarboxylic dianhydride and an aromatic diamine component consisting essentially of 95 mol % to 70 mol % of p-phenylenediamine and 5 mol % to 30 mol % of 2,4-toluenediamine; further preferably prepared from an aromatic tetracarboxylic acid component consisting essentially of 3,3′,4,4′-biphenyltetracarboxylic dianhydride and an aromatic diamine component consisting essentially of 93 mol % to 75 mol % of p-phenylenediamine and 7 mol % to 25 mol % of 2,4-toluenediamine.

In addition to 3,3′,4,4′-biphenyltetracarboxylic dianhydride, p-phenylenediamine and 2,4-toluenediamine, other tetracarboxylic acids or tetracarboxylic dianhydrides and other diamines may be used, as long as the characteristics of the present invention would not be impaired.

A polyimide precursor may be synthesized by random-polymerizing or block-polymerizing substantially equimolar amounts of an aromatic tetracarboxylic dianhydride and an aromatic diamine in an organic solvent. Alternatively, two or more polyimide precursors in which either of these two components is excessive may be prepared, and subsequently, these polyimide precursor solutions may be combined and then mixed under reaction conditions. The polyimide precursor solution thus obtained may be used without any treatment, or may be used after removing or adding a solvent, if necessary, to prepare a self-supporting film.

Examples of an organic solvent for the polyimide precursor solution include N-methyl-2 -pyrrolidone, N,N-dimethylformamide, N,N-dimethylacetamide and N,N-diethylacetamide. These organic solvents may be used alone or in combination of two or more.

The polyimide precursor solution may contain an imidization catalyst, an organic phosphorous-containing compound, an inorganic fine particle, and the like, if necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, hydroxyl-containing aromatic hydrocarbon compounds, and aromatic heterocyclic compounds. Particularly suitable examples of the imidization catalyst used include lower-alkylimidazoles such as 1,2-dimethylimidazole, N-methylimidazole, N-benzyl-2-methylimidazole, 2-methylimidazole, 2-ethyl-4-methylimidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst used is preferably about 0.01 to 2 equivalents, particularly preferably about 0.02 to 1 equivalents relative to the amount of an amide acid unit in a polyamide acid. When the imidization catalyst is used, the polyimide film obtained may have the improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethyleneglycol monotridecyl ether diphosphate, tetraethylene glycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles can be homogeneously dispersed using the known means.

A self-supporting film of a polyimide precursor solution is prepared by flow-casting and applying the above-mentioned solution of a polyimide precursor in an organic solvent, or a polyimide precursor solution composition which is prepared by adding an imidization catalyst, an organic phosphorous-containing compound, an inorganic fine particle, and the like to the above solution, on a support; and then heating it to the extent that the film becomes self-supporting, which means a stage before a common curing process, for example, to the extent that the film can be peeled from the support.

In the present invention, as described above, a polyimide precursor solution with a high concentration may be used. The solid content of the polyimide precursor solution may be preferably 18 wt % or more, more preferably 20 wt % or more, particularly preferably 23 wt % or more. In addition, the solid content of the polyimide precursor solution may be preferably 30 wt % or less, more preferably 27 wt % or less, particularly preferably 26 wt % or less, in view of the prevention of excessively high viscosity of the polyimide precursor solution.

In the present invention, as described above, a self-supporting film of a polyimide precursor solution may be produced at a high film-forming rate. However, when forming a self-supporting film at an excessively high speed, the obtained self-supporting film may have a larger surface roughness, and the obtained polyimide film may be foamed, and a crystal may be formed therein.

In the preparation of a self-supporting film, the heating temperature and the heating time for solvent removal may be appropriately determined. For example, a film of a polyimide precursor solution, which is flow-casted on a support, is heated at 100 to 180° C. for about 3 to 60 min.

A substrate having a smooth surface may be preferably used as a support for a self-supporting film of a polyimide precursor solution. The support used may be a stainless substrate or a stainless belt, for example.

The self-supporting film thus obtained may preferably have an initial elastic modulus of 500 MPa or higher, more preferably 600 MPa or higher, in view of handling properties. The self-supporting film may preferably have an initial elastic modulus of 2 GPa or lower, more preferably 1.8 GPa or lower, particularly preferably 1.6 GPa or lower. When the initial elastic modulus of the self-supporting film is excessively high, it may be difficult to fix the self-supporting film with a pintenter and the like in a curing oven.

It is preferable that a weight loss on heating of a self-supporting film is within a range of 20 to 50 % by weight; and it is further preferable that a weight loss on heating of a self-supporting film is within a range of 20 to 50 % by weight and an imidization rate of a self-supporting film is within a range of 8 to 55 %; by reason that the self-supporting film obtained has sufficient mechanical properties; when a coupling agent solution is applied to the surface of the self-supporting film, it is applied more evenly and more easily; and no foaming, flaws, crazes, cracks and fissures are observed in the polyimide film obtained after imidating.

The weight loss on heating of a self-supporting film as described above is calculated by the following numerical equation from the weight of the self-supporting film (W1) and the weight of the film after curing (W2).

eight loss on heating (% by weight)={(W1−W2)/W1}×100

The imidization rate of a self-supporting film as described above can be calculated based on the ratio of the vibration band peak area or height measured with IR spectrometer (ATR) between the film and a fully-cured product. The vibration band peak utilized in the procedure may include a symmetric stretching vibration band of an imide carbonyl group and a skeletal stretching vibration band of a benzene ring. The imidization rate can be also determined in accordance with the procedure described in Japanese Laid-open Patent Publication No. 1997-316199, using a Karl Fischer moisture meter.

If necessary, a solution containing a surface treatment agent such as a coupling agent and a chelating agent may be applied to one side or both sides of the self-supporting film thus obtained. According to the present invention, a polyimide film having excellent adhesiveness may be produced without applying a solution of a surface treatment agent to the self-supporting film of the polyimide precursor solution.

Examples of the surface treatment agent include various surface treatment agents that improve adhesiveness or adherence, and include various coupling agents and chelating agents such as a silane-based coupling agent, a borane-based coupling agent, an aluminium-based coupling agent, an aluminium-based chelating agent, a titanate-based coupling agent, a iron-based coupling agent, and a copper-based coupling agent. When using a coupling agent such as a silane coupling agent as a surface treatment agent, the more remarkable effect may be achieved.

Examples of the silane-based coupling agent include epoxysilane-based coupling agents such as y-glycidoxypropyl trimethoxy silane, y-glycidoxypropyl diethoxy silane, and β-(3,4-epoxycyclohexyl)ethyl trimethoxy silane; vinylsilane-based coupling agents such as vinyl trichloro silane, vinyl tris(β-methoxy ethoxy) silane, vinyl triethoxy silane, and vinyl trimethoxy silane; acrylsilane-based coupling agents such as y-methacryloxypropyl trimethoxy silane; aminosilane-based coupling agents such as N-β-(aminoethyl)-y-aminopropyl trimethoxy silane, N-β-(aminoethyl)-y-aminopropylmethyl dimethoxy silane, y-aminopropyl triethoxy silane, and N-phenyl-y-aminopropyl trimethoxy silane; y-mercaptopropyl trimethoxy silane, and y-chloropropyl trimethoxy silane. Examples of the titanate-based coupling agent include isopropyl triisostearoyl titanate, isopropyl tridecyl benzenesulfonyl titanate, isopropyl tris(dioctyl pyrophosphate) titanate, tetraisopropyl bis(dioctyl phosphate) titanate, tetra(2,2-diallyloxymethyl-1-butyl) bis(di-tridecyl)phosphate titanate, bis(dioctyl pyrophosphate)oxyacetate titanate, bis(dioctyl pyrophosphate)ethylene titanate, isopropyl trioctanoyl titanate, and isopropyl tricumyl phenyl titanate.

The coupling agent may be preferably a silane-based coupling agent, more preferably an aminosilane-based coupling agents such as y-aminopropyl-triethoxy silane, N-β-(aminoethyl)-y-aminopropyl-triethoxy silane, N-(aminocarbonyl)-y-aminopropyl triethoxy silane, N-[β-(phenylamino)-ethyl]-y-aminopropyl triethoxy silane, N-phenyl-y-aminopropyl triethoxy silane, and N-phenyl-y-aminopropyl trimethoxy silane. Among them, N-phenyl-y-aminopropyl trimethoxy silane is particularly preferable.

Examples of the solvent for the solution containing a surface treatment agent such as a coupling agent and a chelating agent may include those listed as the organic solvent for the polyimide precursor solution (the solvent contained in the self-supporting film). The preferable organic solvent is a solvent compatible with the polyimide precursor solution, and is the same as the organic solvent for the polyimide precursor solution. The organic solvent may be a mixture of two or more compounds.

The content of the surface treatment agent such as a coupling agent and a chelating agent in the surface treatment agent solution (the organic solvent solution) may be preferably 0.5 wt % or more, more preferably 1 wt % to 100 wt %, particularly preferably 3 wt % to 60 wt %, further preferably 5 wt % to 55 wt %. The content of water in the surface treatment agent solution may be preferably 20 wt % or less, more preferably 10 wt % or less, particularly preferably 5 wt % or less. A solution of a surface treatment agent in an organic solvent may preferably have a rotational viscosity (a solution viscosity measured with a rotation viscometer at a measurement temperature of 25° C.) of 10 to 50,000 centipoise.

A particularly preferable solution of a surface treatment agent in an organic solvent may have a low viscosity (specifically, rotational viscosity: 10 to 5,000 centipoise) and comprise a surface treatment agent, which is homogeneously dissolved in an amide solvent, in an amount of 0.5 wt % or more, more preferably 1 wt % to 60 wt %, further preferably 3 wt % to 55 wt %.

The application amount of the solution containing the surface treatment agent may be appropriately determined, and is preferably 1 to 50 g/m², more preferably 2 to 30 g/m², particularly preferably 3 to 20 g/m². The application amount of the surface treatment agent solution to one side may be the same as, or different from the application amount of the surface treatment agent solution to the other side.

The solution containing the surface treatment agent may be applied by any known method; for example, by gravure coating, spin coating, silk screen process, dip coating, spray coating, bar coating, knife coating, roll coating, blade coating, and die coating.

According to the present invention, the self-supporting film, on which a surface treatment agent solution may be applied, if necessary, is then heated to effect imidization, thereby producing a polyimide film.

The preferable heat treatment may be a process in which polymer imidization and solvent evaporation/removal are gradually conducted at about 100 to 400° C. for about 0.05 to 5 hours, particularly 0.1 to 3 hours as the first step. This heat treatment is particularly preferably conducted stepwise, that is, the first heat treatment at a relatively lower temperature of about 100 to 170° C. for about 0.5 to 30 min, then the second heat treatment at 170 to 220° C. for about 0.5 to 30 min, and then the third heat treatment at a high temperature of 220 to 400° C. for about 0.5 to 30 min. If necessary, the fourth high-temperature heat treatment at 400 to 550° C. may be conducted.

It is preferable to fix at least both edges of a long solidified film in the direction perpendicular to the length direction, i.e. in the width direction, with a pintenter, a clip or a frame, for example, and extend or contract the solidified film in the width direction, as necessary, while heating in a curing oven.

In the present invention, a polyimide film may be prepared by, in addition to the thermal imidization as described above, the chemical imidization, or a combination of thermal imidization and chemical imidization. The effect of improving productivity may be more remarkably obtained especially when producing a polyimide film by thermal imidization. In contrast, the effect of improving adhesiveness may be obtained when producing a polyimide film by chemical imidization as well as when producing a polyimide film by thermal imidization. According to the present invention, both a polyimide film produced by chemical imidization and a polyimide film produced by thermal imidization may have excellent adhesive property. The chemical imidization may be conducted by a known method.

Although there are no particular restrictions to the thickness of the polyimide film obtained according to the present invention, it may be about 3 μm to about 250 μm, preferably about 4 μm to about 150 μm, more preferably about 5 μm to about 125 μm, further preferably about 5 μm to about 100 μm.

According to the present invention, a thin film, preferably a thin film with a thickness of 3 μm to 15 μm, more preferably 4 μm to 14 μm, further preferably 5 μm to 13 μm, may be produced from polyimide with high productivity.

According to the present invention, a thick film, preferably a thick film with a thickness of 50 μm to 250 μm, more preferably 60 μm to 225 μm, further preferably 70 μm to 200 μm, may be produced from polyimide with high productivity.

A polyimide film obtained according to the present invention has improved adhesiveness, and therefore a polyimide film having an adhesive, a photosensitive material, a thermocompression-bonding material and the like thereon may be obtained.

A polyimide film obtained according to the present invention has improved adhesiveness, sputtering properties, and metal vapor deposition properties. Therefore, a metal foil such as a copper foil may be attached onto the polyimide film with an adhesive, to give a metal-laminated polyimide film such as a copper-laminated polyimide film having excellent adhesiveness and sufficiently high peel strength. Alternatively, a metal layer such as a copper layer may be formed on the polyimide film by a metallizing method such as sputtering and metal vapor deposition, to give a metal-laminated polyimide film such as a copper-laminated polyimide film having excellent adhesiveness and sufficiently high peel strength. In addition, a metal foil such as a copper foil may be laminated on the polyimide film obtained according to the present invention using a thermocompression-bonding polymer such as a thermocompression-bonding polyimide, to give a metal-laminated polyimide film. A metal layer may be laminated on a polyimide film by a known method.

A thickness of a copper layer in a copper-laminated polyimide film may be appropriately determined depending on an intended application, and is preferably about 1 μm to about 50 μm, more preferably about 2 μm to about 20 μm.

A kind and a thickness of a metal foil, which is attached onto the polyimide film with an adhesive, may be appropriately determined depending on an intended application. Specific examples of the metal foil include a rolled copper foil, an electrolytic copper foil, a copper alloy foil, an aluminum foil, a stainless steel foil, a titanium foil, an iron foil and a nickel foil. The thickness of the metal foil may be preferably about 1 μm to about 50 μm, more preferably about 2 μm to about 20 μm.

Another resin film, a metal such as copper, a chip member such as an IC chip, or the like may be attached onto a polyimide film obtained according to the present invention with an adhesive.

The adhesive to be used may be appropriately selected depending on an intended application, and any known adhesive may be used. For example, an adhesive having excellent insulating properties and excellent adhesion reliability, or an adhesive having excellent conductivity and excellent adhesion reliability such as an ACF, which is bonded by pressure, may be used. A thermoplastic adhesive or a thermosetting adhesive may be also used.

Examples of the adhesive include polyimide adhesives, polyamide adhesives, polyimide-amide adhesives, acrylic adhesives, epoxy adhesives, urethane adhesives, and adhesives comprising two or more thereof. An acrylic adhesive, an epoxy adhesive, a urethane adhesive, or a polyimide adhesive may be particularly preferably used.

The metallizing method is a method for forming a metal layer which is different from metal plating or metal foil lamination, and any known method such as vapor deposition, sputtering, ion plating and electron-beam evaporation may be employed.

Examples of a metal used in the metallizing method include, but not limited to, metals such as copper, nickel, chromium, manganese, aluminum, iron, molybdenum, cobalt, tungsten, vanadium, titanium and tantalum, and alloys thereof, oxides thereof, and carbides thereof. A thickness of a metal layer formed by a metallizing method may be appropriately determined depending on an intended application, and is preferably 1 nm to 500 nm, more preferably 5 nm to 200 nm for a practical use. The number of metal layers formed by a metallizing method may be appropriately determined depending on an intended application, and may be one, two, three or more layers.

A metal-plated layer such as a copper-plated layer and a tin-plated layer may be formed by a known wet plating process such as electrolytic plating or nonelectrolytic plating on the surface of the metal layer of the metal-laminated polyimide film, which is formed by a metallizing method. The thickness of the metal-plated layer such as a copper-plated layer may be preferably 1 μm to 40 μm for a practical use.

According to the present invention, a copper-laminated polyimide film having a 90° peel strength of 0.3 N/mm or higher, further 0.4 N/mm or higher, particularly 0.5 N/mm or higher, for example, may be produced without using a coupling agent for the production of a polyimide film.

The polyimide film of the present invention may be suitably used as an insulating substrate material for FPC, TAB, COF, a metal-wiring board and the like, a cover base material for a metal wiring, a chip such as an IC chip and the like, and a base material for a liquid crystal display, an organic electroluminescent display, an electronic paper, a solar cell and the like.

In such applications, it is preferable that a linear expansion coefficient of a polyimide film is close to a linear expansion coefficient of copper. Specifically, the polyimide film may preferably have a linear expansion coefficient (both MD and TD) of 10 to 40 ppm/° C., more preferably 11 to 30 ppm/° C., particularly preferably 12 to 25 ppm/° C. According to the present invention, there may be provided a polyimide film having excellent adhesiveness and a linear expansion coefficient close to that of copper.

### EXAMPLES

The present invention will be described in more detail below with reference to the Examples. However, the present invention is not limited to these Examples.

The properties of a self-supporting film of a polyimide precursor solution and a polyimide film were evaluated as follows.

### (1) Initial Eelastic Modulus, Breaking Strength, and Breaking Elongation of a Self-Supporting Film and a Polyimide Film

A film was stamped into the dumbbell shape of IEC450 standard to give a test piece. The initial elastic modulus, the breaking strength, and the breaking elongation of the test piece were measured under the conditions of a distance between chucks of 30 mm and a tensile speed of 2 mm/min, using TENSILON manufactured by ORIENTEC Co., Ltd.

### (2) Imidization Rate of a Self-Supporting Film

FT-IR spectra of a self-supporting film and the fully-cured film thereof (polyimide film) were measured according to the ATR method with a Ge crystal at an incident angle of 45°, using a Nicolet Magna 550 FT-IR. The imidization rate was calculated by the following mathematical formula based on the ratio of the peak height of an asymmetric stretching vibration of an imide carbonyl group at 1775 cm⁻¹ to the peak height of a carbon-carbon symmetric stretching vibration of an aromatic ring at 1515 cm⁻.

Imidization rate (%)={peak height at 1515 cm⁻¹ of a self-supporting film/peak height at 1775 cm⁻¹ of a self-supporting film}/{peak height at 1515 cm⁻¹ of a fully-cured film/peak height at 1775 cm⁻¹ of a fully-cured film)}×100

### (3) Weight Loss on Heating of a Self-Supporting Film

The weight loss on heating of a self-supporting film was calculated by the following mathematical formula from the weight of a self-supporting film (W1) and the weight of the film after curing (W2).

Weight loss on heating (% by mass)={(W1−W2)/W1}×100

### (4) Surface Smoothness of a Self-Supporting Film

The surface smoothness of a self-supporting film was evaluated by visual observation. A film which did not have a smooth surface and had a pattern or a step observed was marked by ×, while a film which had no pattern and no step observed was marked by ∘.

### (5) Foaming and Powdering (the Formation of Crystal) of a Polyimide Film

The presence or absence of foaming and powdering of a polyimide film was evaluated by visual observation. A film which had a foaming or a powdering observed was marked by ×, while a film which had no foaming and no powdering observed was marked by ∘.

### (6) Thermal Linear Expansion Coefficient of a Polyimide Film

Using TMA/SS6100 manufactured by SII NanoTechnology Inc., TMA measurement was carried out under the conditions of a test piece width of 4 mm, a measurement length of 15 mm, a load of 2 g or 4 g and a temperature-rising condition of 10° C./min from room temperature to 350° C. The average thermal expansion coefficient at 50° C. to 200° C. was determined from the obtained TMA curve.

### (7) Water Absorption of a Polyimide Film

The obtained polyimide film was dried at 150° C. for 3 hours under vacuum, and the weight of the dried film (W₀) was measured. Subsequently, the film was immersed in water at 23° C. for 24 hours at rest. Then, water on the surface of the film was wiped off with a filter paper, and the weight of the film after water-absorption (W₁) was measured. The water absorption of a polyimide film was calculated by the following mathematical formula (1).

Water absorption (%)=(W₁−W₀)/W₀×100 (1)

### (8) Coefficient of Hygroscopic Expansion (CHE) of a Polyimide Film

In a region of 60 mm×60 mm of a polyimide film, shallow lines were made with a cutter in a lattice shape at an interval of about 30 mm. Then, the film was dried at 150° C. for 3 hours under vacuum. The distance between lattice points of the dried film (L₀), provided that the intersection points of the lines made with a cutter were taken as lattice points, was recorded by 1 μm unit, using a measuring microscope MM-40 manufactured by Nikon Corporation. Subsequently, the film was immersed in water at 23° C. for 24 hours at rest. Then, water on the surface of the film was wiped off with a filter paper, and the distance between lattice points of the film after water-absorption (L₁) was recorded in the same way as in L₀. The coefficient of hygroscopic expansion was calculated by the following mathematical formula (2). The coefficient of hygroscopic expansion (CHE) of one test piece was an average value of the CHEs of three distances between lattice points in each of MD and TD, and the coefficient of hygroscopic expansion of one kind of polyimide film was an average value of the CHEs of three test pieces.

Coefficient of hygroscopic expansion (ppm/RH %)=(L₁−L₀)/L₀/100×10⁶ (2)

### (9) Water Absorption Speed of a Polyimide Film

The obtained polyimide film was dried at 150° C. for 3 hours under vacuum, and the weight of the dried film (W₀) was measured. Subsequently, the film was left at rest in an atmosphere at 23° C. and 50 RH %, and the weight of the film after a time t (Wt) was measured. The water absorption ratio at a time t (Ct) was calculated by the following mathematical formula (3).

Water absorption ratio Ct (%)=(Wₜ−W₀)/W₀100 (3)

The weight (Wt) was measured several times before the film reached saturation in the same way. The diffusion coefficient of water absorption (D) was calculated from the slope (4D^{0.5}/II^{0.5}) of the initial linear portion of the curve obtained by plotting t^{0.5}/L and Ct/Ce.

Ct/Ce=4D^{0.5}/II^{0.5}×t0.5/L

wherein L represents a film thickness, t represents time, D represents a diffusion coefficient, Ct represents the water absorption ratio at a time t, and Ce represents the water absorption ratio at the time of saturation in an atmosphere at 23° C. and 50 RH %.

### (10) Solid Viscoelasticity of a Polyimide Film

The obtained polyimide film was cut into a rectangular test piece of 2 cm×2 mm. The solid viscoelasticity of the test piece was measured in the tensile mode, using RSA III manufactured by TA Instruments. The measurement was carried out at 10 Hz while heating the film from room temperature to the limit temperature at a rate of 3° C./step under a nitrogen stream. The elastic modulus at 400° C. was determined from the obtained E′ curve. In addition, the glass transition temperature (Tg) was determined from the maximum of the E″ curve.

### (11) Adhesive Strength of a Polyimide Film to a Coverlay

A coverlay CVA0525KA manufactured by Arisawa Manufacturing Co., Ltd. was laminated on the obtained polyimide film by pressing at a temperature of 180° C., by a pressure of 3 MPa for 30 minutes. For the laminate thus obtained, the 90° peel strength was measured at a peel speed of 50 mm/min to give the adhesive strength of a polyimide film to a coverlay. The air side when a polyimide precursor solution was cast on a glass plate or a metal support was taken as side A of the film, while the glass plate side or a metal support side was taken as side B of the film.

### (12) Adhesive Strength of a Polyimide Film to Pyralux (90° Peel Strength of a Copper-Laminated Polyimide Film)

An acrylic adhesive (Pyralux LF0100) manufactured by Du Pont and a rolled copper foil (BHY-13H-T, thickness: 18 μm) manufactured by Nippon Mining & Metals Co., Ltd. were laminated on the obtained polyimide film, and the laminate was pressed by a pressure of 9 MPa at a temperature of 180° C. for 5 minutes, and then heat-treated at 180° C. for 60 minutes, to prepare a copper-laminated polyimide film. For the copper-laminated polyimide film thus obtained, the 90° peel strength was measured at a peel speed of 50 mm/min in accordance with JIS C6471-8.1 to give the adhesive strength of a polyimide film to Pyralux. The air side when a polyimide precursor solution was cast on a glass plate or a metal support was taken as side A of the film, while the glass plate side or a metal support side was taken as side B of the film.

### Comparative Example 1

Into a polymerization tank were placed the given amounts of N,N-dimethylacetamide and p-phenylenediamine (PPD). And then, while stirring at a temperature of 40° C., 3,3′,4,4′-biphenyltetracarboxylic dianhydride (s-BPDA) was gradually added to the resulting mixture up to a substantially equimolar amount to p-phenylenediamine, and reacted, to give a polyamic acid solution (polyimide precursor solution) having a solid content of 18 wt %. To the polyamic acid solution were added 0.25 parts by weight of triethanolamine salt of monostearyl phosphate and 0.3 parts by weight of colloidal silica relative to 100 parts by weight of the polyamic acid, and the resulting mixture was homogeneously mixed. The polyamic acid solution composition thus obtained had a rotational viscosity at 30° C. of 200 Pa·s.

The polyamic acid solution composition was cast on a glass plate, to form a thin film thereon. The thin film was heated at 110° C. for 5.5 minutes, and then 160° C. for 4 minutes, using a hot plate, to produce a self-supporting film from the thin film of the polyamic acid solution composition. The self-supporting film obtained was peeled off from the glass plate, and then, while fixing the self-supporting film with a pintenter, the film was imidized by heating it stepwise at 150° C. for 5 minutes, 210° C. for 5 minutes, 310° C. for 5 minutes, and 450° C. for 4 minutes in an oven, to prepare a polyimide film having an average thickness of 75 μm.

The properties of the obtained self-supporting film and the obtained polyimide film are shown in Table 1-1 and Table 1-2, respectively.

### Comparative Examples 2-12

A polyimide film was prepared in the same way as in Comparative Example 1, except that the solid content of the polyimide precursor solution and/or the film-forming rate were changed to those as shown in Table 1-1 and Table 1-2.

In Table 1-1 and Table 1-2, the film-forming rates are expressed by a ratio to the film-forming rate of Comparative Example 1. In each Comparative Example, the heating times at each temperature for producing a self-supporting film from the thin film of the polyamic acid solution composition (the heating times at the casting stage) and the heating times at each temperature for producing a polyimide film by heating the self-supporting film to effect imidization (the heating times at the curing stage) were equally shortened from the heating times in Comparative Example 1 so that the ratio of the film-forming rate in the Comparative Example to the film-forming rate in Comparative Example 1 was the value shown in Table 1-1 and Table 1-2.

The properties of the obtained self-supporting film and the obtained polyimide film are shown in Table 1-1 and Table 1-2, respectively.

### Examples 1-19, Reference Examples 1-4

A polyimide film was prepared in the same way as in Comparative Example 1, except that, in addition to p-phenylenediamine, 2,4-toluenediamine (TDA) was used as an aromatic diamine component in the amount shown in Table 1-1 and Table 1-2, and the solid content of the polyimide precursor solution and/or the film-forming rate were changed to those as shown in Table 1-1 and Table 1-2.

In Table 1-1 and Table 1-2, the film-forming rates are expressed by a ratio to the film-forming rate of Comparative Example 1. As in Comparative Examples 2-12, in each Example, the heating times at the casting stage and the heating times at the curing stage were equally shortened from the heating times in Comparative Example 1 so that the ratio of the film-forming rate in the Example to the film-forming rate in Comparative Example 1 was the value shown in Table 1-1 and Table 1-2. The amounts of 2,4-toluenediamine used are expressed by a ratio to the total molar quantity of the aromatic diamine component (PPD +TDA) in Table 1-1 and Table 1-2.

The properties of the obtained self-supporting film and the obtained polyimide film are shown in Table 1-1 and Table 1-2, respectively.

TABLE 1-1

| | Solid | | Film-forming | Properties of Self-supporting film | | | | | | |
|---|---|---|---|---|---|---|---|---|---|---|
| | content of | | rate | Tensile properties | | | | | Weight | |
| | Polyimide | TDA | (Ratio to | Initial elastic | Breaking | Breaking | Imidization rate | | loss on | |
| | precursor | modification | Comparative | modulus | strength | elongation | Side A | Side B | heating | Surface |
| | solution | rate | Example 1) | (MPa) | (MPa) | (%) | (%) | (%) | (%) | smoothness |
| Comparative Example | 18 wt % | TDA 0 mol % | 1.0 | 560 | 46 | 57 | 20.5 | 46.1 | 37.0 | ◯ |
| 1 | | | | | | | | | | |
| Comparative Example | | | 1.2 | 360 | 38 | 75 | 25.6 | 44.2 | 41.0 | ◯ |
| 2 | | | | | | | | | | |
| Comparative Example | | | 1.4 | 350 | 35 | 75 | 13.3 | 26.4 | 44.7 | X |
| 3 | | | | | | | | | | |
| Comparative Example | | | 1.6 | | | | | | 55.8 | X |
| 4 | | | | | | | | | | |
| Comparative Example | 20 wt % | TDA 0 mol % | 1.0 | | | | | | 37.6 | ◯ |
| 5 | | | | | | | | | | |
| Comparative Example | | | 1.2 | | | | | | 42.3 | ◯ |
| 6 | | | | | | | | | | |
| Comparative Example | | | 1.4 | | | | | | 44.9 | ◯ |
| 7 | | | | | | | | | | |
| Comparative Example | | | 1.6 | | | | | | 51.2 | ◯ |
| 8 | | | | | | | | | | |
| Comparative Example | 22 wt % | TDA 0 mol % | 1.0 | | | | | | 32.9 | ◯ |
| 9 | | | | | | | | | | |
| Comparative Example | | | 1.2 | | | | | | 35.0 | ◯ |
| 10 | | | | | | | | | | |
| Comparative Example | | | 1.4 | | | | | | 41.1 | ◯ |
| 11 | | | | | | | | | | |
| Comparative Example | | | 1.6 | | | | | | 49.0 | ◯ |
| 12 | | | | | | | | | | |
| Example 1 | 22 wt % | TDA 5 mol % | 1.0 | | | | | | 39.2 | ◯ |
| Example 2 | | | 1.2 | | | | | | 39.7 | ◯ |
| Example 3 | | | 1.4 | | | | | | 45.1 | ◯ |
| Reference Example 1 | | | 1.6 | | | | | | 49.6 | ◯ |
| Example 4 | 22 wt % | TDA 10 mol % | 1.0 | 500 | 31 | 48 | 12.3 | 37.8 | 39.5 | ◯ |
| Example 5 | | | 1.2 | 330 | 21 | 39 | 12.3 | 28.7 | 40.6 | ◯ |
| Example 6 | | | 1.4 | 370 | 20 | 40 | 14.3 | 29.7 | 45.7 | ◯ |
| Reference Example 2 | | | 1.6 | 340 | 22 | 43 | 14.8 | 24.5 | 51.6 | X |
| Example 7 | 22 wt % | TDA 30 mol % | 1.0 | 840 | 36 | 24 | 20.2 | 43.5 | 36.6 | ◯ |
| Example 8 | | | 1.2 | 610 | 25 | 24 | 16.3 | 35.7 | 40.5 | ◯ |
| Example 9 | 24 wt % | TDA 10 mol % | 1.0 | 680 | 39 | 35 | 23.1 | 52.1 | 37.7 | ◯ |
| Example 10 | | | 1.2 | 630 | 35 | 39 | 20.2 | 40.8 | 38.0 | ◯ |
| Example 11 | | | 1.4 | 410 | 23 | 39 | 20.5 | 33.4 | 43.0 | ◯ |
| Example 12 | 26 wt % | TDA 10 mol % | 1.0 | 1130 | 62 | 31 | 17.1 | 50.4 | 33.3 | ◯ |
| Example 13 | | | 1.2 | 1070 | 56 | 37 | 24.7 | 51.4 | 39.1 | ◯ |
| Example 14 | | | 1.4 | 860 | 46 | 38 | 20.9 | 41.1 | 41.3 | ◯ |
| Example 15 | 20 wt % | TDA 5 mol % | 1.0 | | | | | | 42.7 | ◯ |
| Example 16 | | | 1.2 | | | | | | 48.4 | ◯ |
| Reference Example 3 | | | 1.4 | | | | | | 53.2 | ◯ |
| Example 17 | 18 wt % | TDA 10 mol % | 1.0 | 560 | 35 | 45 | 15.5 | 36.2 | 36.6 | ◯ |
| Example 18 | | | 1.2 | 210 | 19 | 55 | 10.5 | 23.1 | 41.4 | ◯ |
| Reference Example 4 | | | 1.4 | 130 | 14 | 58 | 10.4 | 21.2 | 49.2 | X |
| Example 19 | 20 wt % | TDA 30 mol % | 1.0 | | | | | | | ◯ |

TABLE 1-2

| | Solid | | Film-forming | Properties of Cured film (Polyimide film) | | | | |
|---|---|---|---|---|---|---|---|---|
| | content of | | rate | Tensile properties | | | | |
| | Polyimide | TDA | (Ratio to | Initial elastic | Breaking | Breaking | | |
| | precursor | modification | Comparative | modulus | strength | elongation | | |
| | solution | rate | Example 1) | (Gpa) | (MPa) | (%) | Foaming | Powdering |
| Comparative Example | 18 wt % | TDA 0 mol % | 1.0 | 6.4 | 245 | 22 | ◯ | ◯ |
| 1 | | | | | | | | |
| Comparative Example | | | 1.2 | 5.5 | 241 | 27 | ◯ | ◯ |
| 2 | | | | | | | | |
| Comparative Example | | | 1.4 | 4.9 | 204 | 23 | ◯ | ◯ |
| 3 | | | | | | | | |
| Comparative Example | | | 1.6 | | | | X | X |
| 4 | | | | | | | | |
| Comparative Example | 20 wt % | TDA 0 mol % | 1.0 | 6.4 | 203 | 14 | ◯ | ◯ |
| 5 | | | | | | | | |
| Comparative Example | | | 1.2 | 5.6 | 171 | 12 | ◯ | ◯ |
| 6 | | | | | | | | |
| Comparative Example | | | 1.4 | 5.1 | 179 | 12 | ◯ | ◯ |
| 7 | | | | | | | | |
| Comparative Example | | | 1.6 | | | | X | X |
| 8 | | | | | | | | |
| Comparative Example | 22 wt % | TDA 0 mol % | 1.0 | 6.5 | 227 | 20 | ◯ | ◯ |
| 9 | | | | | | | | |
| Comparative Example | | | 1.2 | 5.5 | 200 | 13 | ◯ | ◯ |
| 10 | | | | | | | | |
| Comparative Example | | | 1.4 | 5.2 | 206 | 11 | ◯ | ◯ |
| 11 | | | | | | | | |
| Comparative Example | | | 1.6 | | | | X | X |
| 12 | | | | | | | | |
| Example 1 | 22 wt % | TDA 5 mol % | 1.0 | 5.7 | 218 | 17 | ◯ | ◯ |
| Example 2 | | | 1.2 | 6.0 | 224 | 19 | ◯ | ◯ |
| Example 3 | | | 1.4 | 4.7 | 178 | 17 | ◯ | ◯ |
| Reference Example 1 | | | 1.6 | | | | X | X |
| Example 4 | 22 wt % | TDA 10 mol % | 1.0 | 5.7 | 219 | 22 | ◯ | ◯ |
| Example 5 | | | 1.2 | 5.9 | 252 | 29 | ◯ | ◯ |
| Example 6 | | | 1.4 | 5.7 | 241 | 24 | ◯ | ◯ |
| Reference Example 2 | | | 1.6 | | | | X | X |
| Example 7 | 22 wt % | TDA 30 mol % | 1.0 | 4.8 | 238 | 31 | ◯ | ◯ |
| Example 8 | | | 1.2 | 4.7 | 212 | 21 | ◯ | ◯ |
| Example 9 | 24 wt % | TDA 10 mol % | 1.0 | 6.0 | 211 | 26 | ◯ | ◯ |
| Example 10 | | | 1.2 | 6.2 | 269 | 33 | ◯ | ◯ |
| Example 11 | | | 1.4 | 5.9 | 221 | 19 | ◯ | ◯ |
| Example 12 | 26 wt % | TDA 10 mol % | 1.0 | 6.1 | 242 | 27 | ◯ | ◯ |
| Example 13 | | | 1.2 | 6.0 | 269 | 30 | ◯ | ◯ |
| Example 14 | | | 1.4 | 6.0 | 254 | 31 | ◯ | ◯ |
| Example 15 | 20 wt % | TDA 5 mol % | 1.0 | 6.0 | | 28 | ◯ | ◯ |
| Example 16 | | | 1.2 | 6.0 | | 25 | ◯ | ◯ |
| Reference Example 3 | | | 1.4 | 5.5 | | 16 | X | X |
| Example 17 | 18 wt % | TDA 10 mol % | 1.0 | 6.2 | 282 | 33 | ◯ | ◯ |
| Example 18 | | | 1.2 | 6.0 | 264 | 31 | ◯ | ◯ |
| Reference Example 4 | | | 1.4 | | | | X | X |
| Example 19 | 20 wt % | TDA 30 mol % | 1.0 | 5.0 | 204 | 30 | ◯ | ◯ |

The results of Examples and Comparative Examples shown in Table 1-1 and Table 1-2 indicate the following matters:

(1) It is apparent from Comparative Examples 1-12 that when producing a polyimide film of s-BPDA/PPD at a higher film-forming rate, the obtained polyimide film had lower tensile properties, and was more frangible. In contrast, it is apparent from Examples 1-3, Examples 4-6, Examples 7-8, Examples 9-11, Examples 12-14, Examples 15-16 and Examples 17-18 that when producing a polyimide film in which 2,4-toluenediamine is copolymerized (s-BPDA/PPD+TDA; sometimes referred to as TDA polyimide) at a higher film-forming rate, the obtained polyimide film had sufficiently high properties such as tensile properties.

(2) It is apparent from Comparative Examples 1-3 that when producing a polyimide film at a higher film-forming rate using a polyimide precursor solution of s-BPDA/PPD with a solid content of 18 wt %, the obtained self-supporting film of the polyimide precursor solution had a lower initial elastic modulus. In contrast, it is apparent from Examples 7-10 and Examples 12-14 that the self-supporting film obtained from the polyimide precursor solution of s-BPDA/PPD+TDA with a high concentration (solid content: 22 wt % to 26 wt %) had an initial elastic modulus of 500 MPa or higher, and excellent handling properties.

(3) It is apparent from Examples 4-6, Examples 9-11 and Examples 12-14 that when producing a polyimide film of s-BPDA/PPD+TDA using a polyimide precursor solution with a higher concentration, the obtained polyimide film had sufficiently high properties such as tensile properties.

The solution of the polyimide precursor of s-BPDA/PPD+TDA used in Examples 1-19 does not gel after being left at room temperature for at least two weeks. It is confirmed that a solution of a polyimide precursor of s-BPDA/PPD with a high concentration has less storage stability than a solution of a polyimide precursor of s-BPDA/PPD+TDA.

### Examples 20-22

A polyimide precursor solution composition with a solid content of 24 wt % in which TDA was introduced into the polyimide precursor in an amount of 10 mol % based on the total molar quantity of the aromatic diamine component was prepared in the same way as in Examples 9-11. The polyimide precursor solution composition thus obtained was continuously casted from a slit of a T-die mold and extruded on a smooth metal support in a drying oven, to form a thin film on the support. The thin film was heated at 155° C. for a predetermined time, and then peeled off from the support to give a self-supporting film.

Subsequently, the self-supporting film was fed into a continuous heating oven (curing oven) while fixing both edges of the film in the width direction, and the film was heated from 100° C. to the highest heating temperature of 450° C. in the oven to effect imidization, thereby producing a long polyimide film having an average thickness of about 75 μm. In these Examples, the film-forming rates were 1.1, 1.2 and 1.3 times, respectively, relative to the film-forming rate of Comparative Example 13, as shown in Table 2.

The properties of the obtained polyimide film are shown in Table 2.

### Comparative Example 13

A long polyimide film having an average thickness of about 75 μm was produced in the same way as in Examples 20-22, except that a polyimide precursor solution composition with a solid content of 18 wt % in which no TDA was introduced into the polyimide precursor, i.e. a solution of a polyimide precursor of s-BPDA/PPD, was prepared and used, the casting temperature was 150° C., and the film-forming rate was the reference rate (1.0 times).

The properties of the obtained polyimide film are shown in Table 2.

TABLE 2

| | | | | | Comparative |
|---|---|---|---|---|---|
| | | Example 20 | Example 21 | Example 22 | Example 13 |
| Solid content of Polyimide precursor solution (wt %) | | 24 | 24 | 24 | 18 |
| TDA modification rate (mol %) | | 10 | 10 | 10 | 0 |
| Film-forming rate | | 1.1 | 1.2 | 1.3 | 1.0 |
| (Ratio to Comparative Example 13) | | | | | |
| Average thickness (μm) | | 82 | 76 | 75 | 76 |
| Thermal linear expansion coefficient (ppm/° C.) | | 23 | 25 | 24 | 22 |
| Initial elastic modulus (GPa) | | 5.6 | 5.8 | 5.8 | 6.2 |
| Breaking strength (MPa) | | 230 | 230 | 230 | 270 |
| Breaking elongation (%) | | 23 | 24 | 24 | 26 |
| E′ at 400° C. (GPa) | | 0.95 | 1.0 | 0.99 | 1.4 |
| Tg (° C.) | | 326 | 326 | 326 | |
| Water absorption (%) | | 1.7 | | 1.7 | 1.6 |
| Immersed in water at 23° C. for 24 h | | | | | |
| CHE (ppm/RH %) | | 18 | | 18 | 16 |
| Immersed in water at 23° C. for 24 h | | | | | |
| Water absorption speed (10⁻¹⁴ m²/S) | | 3.9 | | 4.3 | 1.0 |
| 23° C., 0→50% RH | | | | | |
| Adhesive strength to Coverlay (kN/m) | Side A | | | 1.4 | 0.91 |
| | Side B | | | 1.2 | 1.1 |
| Adhesive strength to Pyralux (kN/m) | Side A | 1.8 | | 2.1 | 1.5 |
| | Side B | 2.0 | | 2.1 | 1.8 |

It is apparent from Examples 20-22 shown in Table 2 that when producing a s-BPDA/PPD+TDA polyimide film at a higher film-forming rate, the obtained polyimide film had sufficiently high tensile properties. Furthermore, the s-BPDA/PPD+TDA polyimide had a high elastic modulus at a high temperature, a high glass transition temperature, and an excellent heat resistance.

Furthermore, the polyimide into which TDA was introduced in an amount of 10 mol % based on the total molar quantity of the aromatic diamine component had an improved adhesiveness, as compared to a polyimide into which no TDA was introduced, i.e. s-BPDA/PPD polyimide. A metal layer such as a metal foil may be laminated on the polyimide film of the present invention directly, or alternatively, via an adhesive layer or a thermocompression-bonding polymer layer, to give a metal-laminated polyimide film having excellent adhesiveness or adhesion.

In addition, when TDA was introduced into the polyimide in an amount of 10 mol % based on the total molar quantity of the aromatic diamine component, while the water absorption was slightly increased, the water absorption speed was 3 times to 4 times faster. When using a metal-laminated polyimide film wherein a metal layer such as a metal foil is laminated on the polyimide film of the present invention directly, or alternatively, via an adhesive layer or a thermocompression-bonding polymer layer, foaming and peeling in an adhesive interface may be seldom caused by high-temperature treatment process in the production of a wiring board, for example.

The polyimide film of the present invention may be suitably used as an insulating substrate material for FPC, TAB, COF, a metal-wiring board and the like, a cover base film for a metal wiring and the like, and a base material for a solar cell and the like.

### Example 23

A polyimide precursor solution composition with a solid content of 24 wt % in which TDA was introduced into the polyimide precursor in an amount of 10 mol % based on the total molar quantity of the aromatic diamine component was prepared in the same way as in Examples 9-11. The polyimide precursor solution composition thus obtained was continuously casted from a slit of a T-die mold and extruded on a smooth metal support in a drying oven, to form a thin film on the support. The thin film was heated at 140° C. for a predetermined time, and then peeled off from the support to give a self-supporting film.

Subsequently, the self-supporting film was fed into a continuous heating oven (curing oven) while fixing both edges of the film in the width direction, and the film was heated from 100° C. to the highest heating temperature of 450° C. in the oven to effect imidization, thereby producing a long polyimide film having an average thickness of 12 μm.

The properties of the obtained polyimide film are shown in Table 3.

### Example 24

A polyimide precursor solution composition with a solid content of 24 wt % in which TDA was introduced into the polyimide precursor in an amount of 10 mol % based on the total molar quantity of the aromatic diamine component was prepared in the same way as in Examples 9-11. To the polyimide precursor solution composition thus obtained was added 0.05 equivalent of 1,2-dimethylimidazole relative to the amount of an amide acid unit. And then, using this polyimide precursor solution composition, a long polyimide film having an average thickness of 12 μm was continuously produced in the same way as in Example 23.

The properties of the obtained polyimide film are shown in Table 3.

### Example 25

A long polyimide film having an average thickness of 13 μm was produced in the same way as in Example 24, except that a polyimide precursor solution composition with a solid content of 20 wt % in which TDA was introduced into the polyimide precursor in an amount of 20 mol % based on the total molar quantity of the aromatic diamine component was prepared and used.

The properties of the obtained polyimide film are shown in Table 3.

### Comparative Example 14

A long polyimide film having an average thickness of 12 μm was produced in the same way as in Examples 24-25, except that a polyimide precursor solution composition with a solid content of 18 wt % in which no TDA was introduced into the polyimide precursor, i.e. a solution of a polyimide precursor of s-BPDA/PPD, was prepared and used.

The properties of the obtained polyimide film are shown in Table 3.

### Example 26

A long polyimide film having an average thickness of 5.8 μm was produced in the same way as in Example 24, except that the amount of 1,2-dimethylimidazole added was 0.15 equivalent relative to the amount of an amide acid unit, and the casting temperature was 147° C.

The properties of the obtained polyimide film are shown in Table 3.

### Example 27

A long polyimide film having an average thickness of 5.5 μm was produced in the same way as in Example 26, except that a polyimide precursor solution composition with a solid content of 20 wt % in which TDA was introduced into the polyimide precursor in an amount of 20 mol % based on the total molar quantity of the aromatic diamine component was prepared and used, and the casting temperature was 140° C.

The properties of the obtained polyimide film are shown in Table 3.

### Example 28

A long polyimide film having an average thickness of 5.6 μm was produced in the same way as in Example 27, except that the amount of 1,2-dimethylimidazole added was 0.05 equivalent relative to the amount of an amide acid unit.

The properties of the obtained polyimide film are shown in Table 3.

### Comparative Example 15

A long polyimide film having an average thickness of 5.1 μm was produced in the same way as in Example 26, except that a polyimide precursor solution composition with a solid content of 18 wt % in which no TDA was introduced into the polyimide precursor, i.e. a solution of a polyimide precursor of s-BPDA/PPD, was prepared and used, and the casting temperature was 150° C.

The properties of the obtained polyimide film are shown in Table 3.

### Reference Example 5

A polyimide precursor solution composition was prepared in the same way as in Examples 9-11, except that the solid content of the polyimide precursor solution was 18 wt %, and TDA was introduced into the polyimide precursor in an amount of 20 mol % based on the total molar quantity of the aromatic diamine component. The polyimide precursor solution composition thus obtained had a rotational viscosity at 30° C. of 40 Pa·s.

### Reference Example 6

A polyimide precursor solution composition was prepared in the same way as in Examples 9-11, except that the solid content of the polyimide precursor solution was 18 wt %, and 100 mol % of TDA was used as an aromatic diamine component. The polyimide precursor solution composition thus obtained had a rotational viscosity at 30° C. of 30 Pa·s.

TABLE 3

| | | Example | Example | Example | Comparative | Example | Example | Example | Comparative |
|---|---|---|---|---|---|---|---|---|---|
| | | 23 | 24 | 25 | Example 14 | 26 | 27 | 28 | Example 15 |
| TDA modification rate | | 10 | 10 | 20 | 0 | 10 | 20 | 20 | 0 |
| (mol %) | | | | | | | | | |
| Solid content of Polyimide | | 24 | 24 | 20 | 18 | 24 | 20 | 20 | 18 |
| precursor solution (wt %) | | | | | | | | | |
| Amount of Imidization | | 0 | 0.05 | 0.05 | 0.05 | 0.15 | 0.15 | 0.05 | 0.15 |
| catalyst (equivalent) | | | | | | | | | |
| Average thickness (μm) | | 12 | 12 | 13 | 12 | 5.8 | 5.5 | 5.6 | 5.1 |
| Thermal linear | | 15 | 14 | 17 | 11 | 12 | 22 | 14 | 16 |
| expansion coefficient | | | | | | | | | |
| (ppm/° C.) | | | | | | | | | |
| Initial elastic modulus | | 7.9 | 7.2 | 6.4 | 8.0 | 7.3 | 6.3 | 7.1 | 7.1 |
| (GPa) | | | | | | | | | |
| Breaking strength (MPa) | | 300 | 350 | 360 | 420 | 330 | 260 | 350 | 280 |
| Breaking elongation (%) | | 16 | 33 | 43 | 32 | 32 | 30 | 34 | 24 |
| E′ at 400° C. (GPa) | | | 0.58 | 0.27 | 0.60 | 0.56 | | | |
| Tg (° C.) | | | 311 | 317 | | 311 | | | |
| CHE (ppm/RH %) | | 13 | 11 | 12 | 8.5 | 8.2 | | 7.9 | 7.2 |
| Immersed in | | | | | | | | | |
| water at 23° C. for 24 h | | | | | | | | | |
| Adhesive strength | Side A | 0.44 | 0.43 | 0.58 | 0.21 | 0.28 | 0.36 | 0.35 | 0.19 |
| to Coverlay | Side B | 0.54 | 0.46 | 1.5 | 0.24 | 0.40 | 0.36 | 0.79 | 0.22 |
| (kN/m) | | | | | | | | | |
| Adhesive strength | Side A | | 0.50 | 0.61 | 0.33 | 0.35 | 0.46 | | 0.30 |
| to Pyralux (kN/m) | Side B | | 0.53 | 0.74 | 0.33 | 0.40 | 0.48 | | 0.25 |

As seen from Table 3, the s-BPDA/PPD+TDA polyimide film with a thickness of 5 μm to 13 μm had a linear expansion coefficient close to that of copper foil. Furthermore, the s-BPDA/PPD+TDA polyimide film with a thickness of 5 μm to 13 μm also had an improved adhesiveness, as compared to a polyimide film into which no TDA was introduced, i.e. s-BPDA/PPD polyimide film. In addition, the s-BPDA/PPD+TDA polyimide film had a high elastic modulus at a high temperature, a high glass transition temperature, and an excellent heat resistance. A metal layer such as a metal foil may be laminated on the polyimide film of the present invention directly, or alternatively, via an adhesive layer or a thermocompression-bonding polymer layer, to give a metal-laminated polyimide film having excellent adhesiveness or adhesion. The polyimide film of the present invention may be suitably used as an insulating substrate material for FPC, TAB, COF, a metal-wiring board and the like, a cover base film for a metal wiring and the like, and a base material for a solar cell and the like.

### INDUSTRIAL APPLICABILITY

As described above, according to the present invention, the productivity may be improved in the production of a polyimide film prepared from an aromatic tetracarboxylic acid component comprising 3,3′,4,4′-biphenyltetracarboxylic dianhydride as a main component and an aromatic diamine component comprising p-phenylenediamine as a main component. Furthermore, the obtained polyimide film may have a high water absorption speed, and an excellent adhesiveness. The polyimide film of the present invention may be suitably used as an insulating substrate material for FPC, TAB, COF, a metal-wiring board and the like, a film for a cover base material for a metal wiring and the like, and a base material for a solar cell and the like.

1. A polyimide film prepared from an aromatic tetracarboxylic acid component comprising 3,3′,4,4′-biphenyltetracarboxylic dianhydride as a main component and an aromatic diamine component comprising p-phenylenediamine as a main component; wherein
the aromatic diamine component comprises not less than 3 mol % but less than 35 mol % of 2,4-toluenediamine based on the total molar quantity of the aromatic diamine component.

2. The polyimide film as claimed in claim 1, wherein the aromatic diamine component comprises 5 mol % to 30 mol % of 2,4-toluenediamine based on the total molar quantity of the aromatic diamine component.

3. The polyimide film as claimed in claim 1, wherein the polyimide film has a thickness of 3 μm to 250 μm.

4. The polyimide film as claimed in claim 1, wherein the polyimide film has a thickness of 75 μm to 250 μm.

5. A process for producing a polyimide film as claimed in claim 1, comprising steps of:
providing a solution of a polyimide precursor prepared from an aromatic tetracarboxylic acid component consisting essentially of 3,3′,4,4′-biphenyltetracarboxylic dianhydride and an aromatic diamine component consisting essentially of not less than 65 mol % but less than 97 mol % of p-phenylenediamine and not less than 3 mol % but less than 35 mol % of 2,4-toluenediamine;
flow-casting the solution of the polyimide precursor on a support and heating it, thereby preparing a self-supporting film of a polyimide precursor solution; and
heating the self-supporting film to effect imidization.

6. The process for producing a polyimide film as claimed in claim 5, wherein the solution of the polyimide precursor which is flow-casted on a support has a solid content of 18 wt % to 30 wt %.

7. The process for producing a polyimide film as claimed in claim 5, wherein the self-supporting film produced has an initial elastic modulus of 500 MPa or higher.

8. A copper-laminated polyimide film, wherein a copper foil is laminated on the surface of the polyimide film as claimed in claim 1 via an adhesive layer or a thermocompression-bonding layer.

9. The copper-laminated polyimide film as claimed in claim 8, wherein the copper-laminated polyimide film has a 90° peel strength of 0.3 N/mm or higher.
